(19) United States
(12) Patent Application Publication
(10) Pub. No.: US 2007/0280636 A1
(43) Pub. Date: Dec. 6, 2007

(54) RECORD/REPLAY APPARATUS, RECORD/REPLAY METHOD, AND PROGRAM

(75) Inventor: Keiji Adachi, Kawasaki-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/749,320

(22) Filed: May 16, 2007

(30) Foreign Application Priority Data
May 31, 2006 (JP) 2006-152149

(51) Int. Cl. H04N 5/91

(52) U.S. Cl. 386/83

(57) ABSTRACT

The record/replay apparatus includes a broadcast program receiver which receives a broadcast program, a broadcast program storage unit adapted to store the broadcast program received by the broadcast program receiver, an evaluation value transceiver adapted to obtain the evaluation values of broadcast programs via a network from an evaluation value accumulation server that stores the evaluation values of broadcast programs, an evaluation value processing unit adapted to decide a broadcast program to be deleted based on the evaluation values obtained by the evaluation value transceiver, and a broadcast program deletion unit adapted to automatically delete the broadcast program, deletion of which is decided by the evaluation value processing unit, from the broadcast program storage unit.

### BACKGROUND OF THE INVENTION

1. Field of the Invention

The present invention relates to a record/replay apparatus, record/replay method, and program which record and replay a broadcast program and, more particularly, to a record/replay apparatus, record/replay method, and program which automatically delete a broadcast program received from a server based on the evaluation value of the broadcast program.

2. Description of the Related Art

Recently, broadcast program record/replay apparatuses such as a hard disk video recorder and personal computer have become on the market. The broadcast program record/replay apparatus receives contents such as programs broadcast by terrestrial broadcasting, satellite broadcasting, cable television, Internet, and the like. The broadcast program record/replay apparatus records broadcast programs on a large-capacity storage medium such as a hard disk, and replays them.

The broadcast program record/replay apparatus allows the user to perform manual recording, and also allows him to reserve automatic recording of a target broadcast program in advance.

However, the storage capacity of the hard disk is limited. If many broadcast programs or a long broadcast program is recorded on the hard disk, the available storage capacity of the hard disk runs short, and the hard disk cannot record any more.

To record a new broadcast program, the user must delete recorded program contents to ensure an available storage capacity of the hard disk. At this time, the user must confirm many recorded contents to select ones which can be deleted. The selection, deletion, and the like are cumbersome.

As a prior art, Japanese Patent Laid-Open No. 8-115333 proposes a technique of giving time information to each pieces of video information stored in a video information accumulation unit. When video information in the video information accumulation unit exceeds a predetermined accumulation amount, the oldest video information is deleted to ensure an available storage capacity.

Japanese Patent Laid-Open No. 2002-112150 proposes a technique of deleting viewed or old contents when the remaining storage capacity of the hard disk runs short in recording.

Japanese Patent Laid-Open No. 2000-184320 proposes a simple, time-free viewable system which always continues to record broadcast programs by a predetermined number or predetermined time. The system saves the storage capacity by deleting some broadcast programs or broadcast programs which exceed the predetermined number or predetermined time.

Japanese Patent Laid-Open No. 2005-94115 proposes a technique of reducing user workload to search many contents for desired ones. For this purpose, contents recommended to each user are displayed on the screen, and contents which meet user preferences are displayed on the screen, reducing the burden on the user.

However, the above-described prior arts may not delete specific contents desired by the user.

For example, when given contents are determined and deleted based on update time information and the view count of contents, contents the user is actually interested in may be deleted.

The user may want not to delete but to preserve a high-quality broadcast program or a broadcast program highly evaluated by other viewers. However, even such contents may be deleted without any regard for this.

### SUMMARY OF THE INVENTION

The present invention has been made to overcome the conventional drawbacks, and has as its object to provide a record/replay apparatus, record/replay method, and program capable of providing only high-quality broadcast programs to the user while freeing the user from a cumbersome broadcast program confirmation operation, broadcast program selection operation, and broadcast program deletion operation.

One aspect of the preferred embodiments of the present invention relates to a record/replay apparatus comprising, a receiver which receives a broadcast program, a storage unit adapted to store the broadcast program received by the receiver, an obtaining unit adapted to obtain evaluation values of broadcast programs via a network from an accumulation server that stores evaluation values of broadcast programs, a processing unit adapted to decides a broadcast program to be deleted based on the evaluation values obtained by the obtaining unit, and a deletion unit adapted to automatically delete the broadcast program, deletion of which is decided by the processing unit, from the storage unit.

One aspect of the preferred embodiments of the present invention relates to a record/replay method comprising, receiving a broadcast program, storing the received broadcast program in a storage unit, obtaining evaluation values of broadcast programs via a network from an accumulation server that stores evaluation values of broadcast programs, deciding a broadcast program to be deleted based on the obtained evaluation values, and automatically deleting the broadcast program, deletion of which is decided, from the storage unit.

One aspect of the preferred embodiments of the present invention relates to a program which is stored in a computer-readable storage medium, and causes a computer to execute receiving a broadcast program, storing the received broadcast program received in a storage unit, obtaining evaluation values of broadcast programs via a network from an accumulation server that stores evaluation values of broadcast programs, deciding a broadcast program to be deleted based on the obtained evaluation values, and automatically deleting the broadcast program, deletion of which is decided, from the storage unit.

Further features of the present invention will become apparent from the following description of exemplary embodiments (with reference to the attached drawings).

### BRIEF DESCRIPTION OF THE DRAWINGS

FIG. 1 is a view showing the overall arrangement of a record/replay apparatus according to an embodiment of the present invention;

FIG. 2 is a functional block diagram of a record/replay apparatus according to the first embodiment of the present invention;

FIG. 3 is a functional block diagram showing an example of the arrangement of an evaluation value accumulation server according to the first embodiment of the present invention;

FIG. 4 is a flowchart showing process procedures by the record/replay apparatus according to the first embodiment of the present invention;

FIG. 5 is a flowchart showing process procedures by the evaluation value accumulation server according to the first embodiment of the present invention;

FIG. 6 is a functional block diagram of a record/replay apparatus according to the second embodiment of the present invention;

FIG. 7 is a flowchart showing the procedures of an evaluation input process according to the second embodiment of the present invention; and

FIG. 8 is a flowchart showing process procedures by the record/replay apparatus according to the second embodiment of the present invention.

### DESCRIPTION OF THE EMBODIMENTS

### First Embodiment

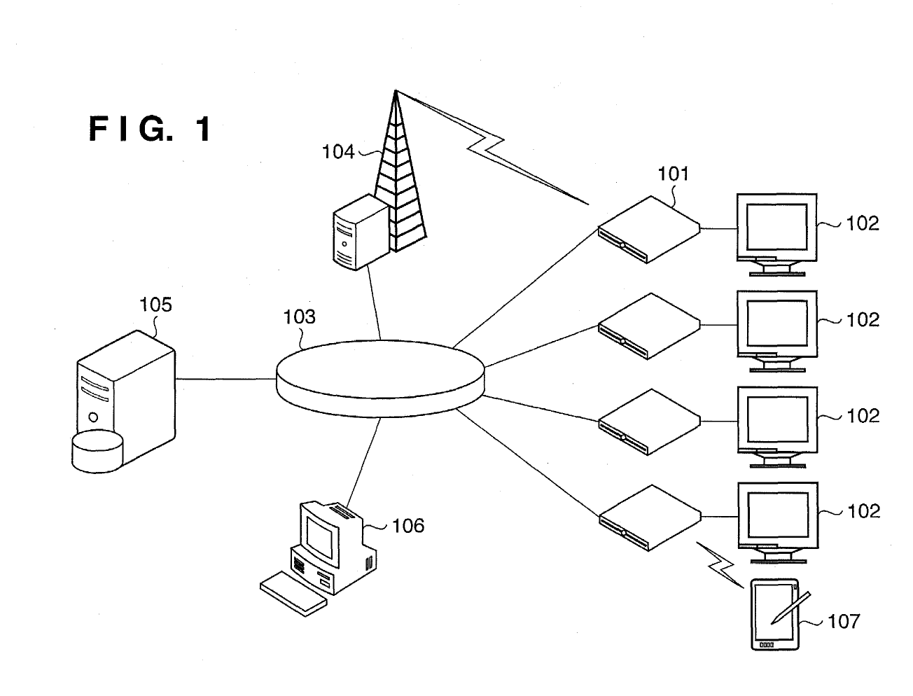

The first embodiment of the present invention will be described in detail below with reference to the accompanying drawings. FIG. 1 is a view showing an example of the overall arrangement of a record/replay apparatus to which the present invention is applied.

In FIG. 1, each record/replay apparatus 101 is a hard disk recorder. The record/replay apparatus 101 incorporates a storage device such as a hard disk, is connected to a network 103 such as the Internet, and can record and replay images and sounds such as a TV broadcast program from a broadcast station or network.

A display apparatus 102 displays, for example, an image output from the record/replay apparatus 101, and a user interface (UI) for setting and operating the record/replay apparatus 101.

A broadcast station or broadcast company 104 for TV broadcasting, BS broadcasting, CS broadcasting, cable television broadcasting, or the like distributes broadcast programs.

An evaluation value accumulation server 105 records the evaluation values of delivered broadcast program contents. An input unit 107 such as a remote controller or touch panel enables various inputs and operations to the record/replay apparatus 101.

The evaluation value is a value representing the evaluation of a broadcast program, and is decided by the rating, an evaluation by a critic or expert, the attention of a broadcast program such as the reputation, the recommendation grade by a broadcast station, or the like. These values can also be input from an evaluation value input terminal 106.

In many cases, broadcast program contents to be deleted have been recorded, and other users have already viewed them. As information to decide an evaluation value, therefore, the rating of the broadcast program, information transmitted from each record/replay apparatus, or the like is also available.

Pieces of information can be totaled from many users and utilized as a highly reliable evaluation value.

For example, a broadcast program reserved by many users, or a broadcast program replayed a number of times or for a long time is considered to be a high-quality broadcast program many users are interested in.

To the contrary, a broadcast program of an old recording date & time, or a broadcast program replayed only a small number of times is considered to be a broadcast program only few users are interested in.

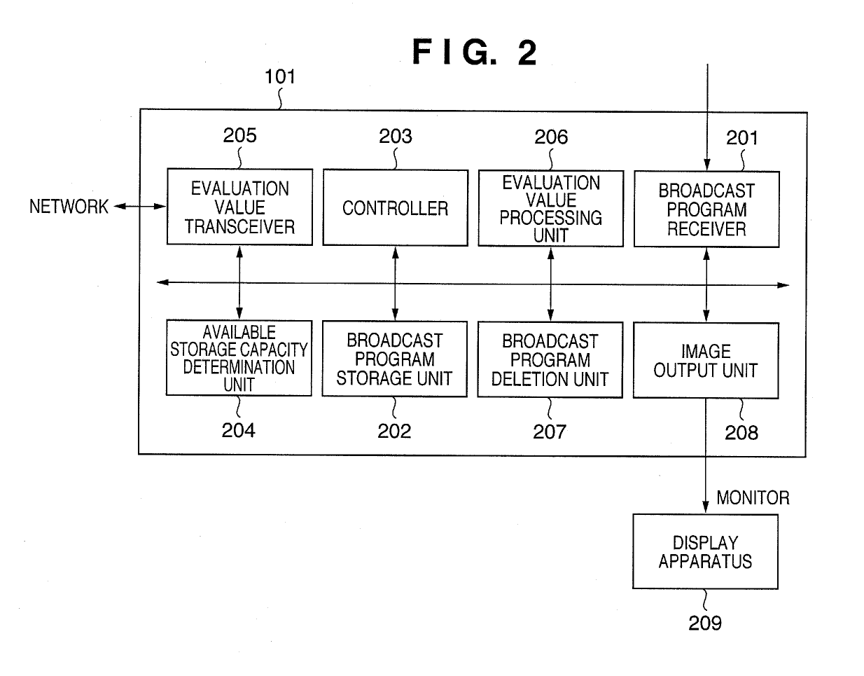

FIG. 2 is a functional block diagram showing an example of the arrangement of the record/replay apparatus according to the first embodiment to which the present invention is applied. In FIG. 2, the record/replay apparatus 101 comprises a broadcast program receiver 201, broadcast program storage unit 202, controller 203, available storage capacity determination unit 204, evaluation value transceiver 205, evaluation value processing unit 206, broadcast program deletion unit 207, and image output unit 208.

The broadcast program receiver 201 includes a tuner, and receives broadcast waves and broadcast program contents such as video data and audio data from a network. The broadcast program storage unit 202 stores a received broadcast program in a storage medium such as a hard disk.

The controller 203 includes a CPU, MPU, and the like, and performs various control operations for the record/replay apparatus 101. When the user issues a recording request for manual recoding or recording programming, the available storage capacity determination unit 204 obtains the current available storage capacity of the broadcast program storage unit 202, and determines whether the available storage capacity is sufficient to store a broadcast program to be recorded. It is also possible to set the minimum value of the available storage capacity in advance and determine whether the available storage capacity becomes equal to or smaller than the set value, even if the user does not issue a recording request.

The evaluation value transceiver 205 is connected to the evaluation value accumulation server 105 via the network 103 to transmit/receive an evaluation value and information used to decide an evaluation value.

When the broadcast program storage unit 202 does not have a sufficient available storage capacity, the evaluation value transceiver 205 transmits an obtainment request for the evaluation values of broadcast programs to the evaluation value accumulation server in order to decide a broadcast program to be deleted from recorded programs.

In the case of setting the minimum value of the available storage capacity in advance, when the available storage capacity becomes equal to or smaller than the set value, the evaluation value transceiver 205 transmits an evaluation value obtainment request to the evaluation value accumulation server 105. After transmitting the evaluation value obtainment request to the evaluation value accumulation server 105, the evaluation value transceiver 205 receives the evaluation values of broadcast programs.

The evaluation value transceiver 205 properly transmits, to the evaluation value accumulation server 105, information serving as a reference to decide the evaluation value of a broadcast program. Examples of this information are reserved broadcast program information when the user reserves a broadcast program, and information on the replay count, replay time, and recording date & time of a broadcast program recorded by the user.

The evaluation value processing unit 206 decides to delete a broadcast program of the lowest evaluation value among broadcast programs stored in the broadcast program storage unit 202. The delete broadcast program decision process is repeated until a sufficient available storage capacity is ensured.

The broadcast program deletion unit 207 deletes a broadcast program designated by the evaluation value processing unit 206. The image output unit 208 is connected to an external display apparatus 209, and outputs video data of a broadcast program to the display apparatus 209.

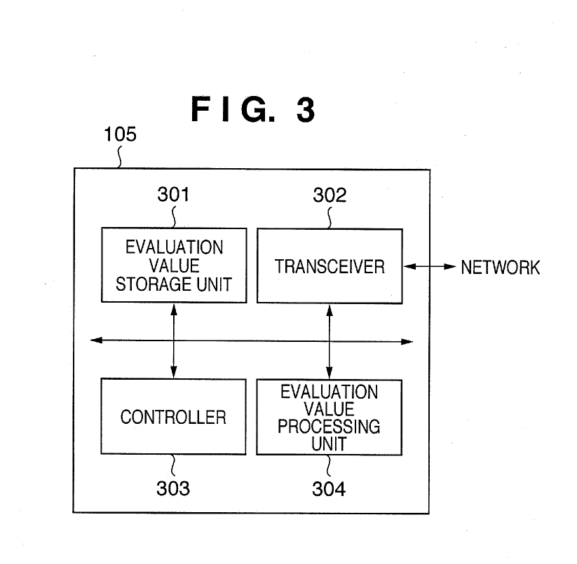

FIG. 3 is a functional block diagram showing an example of the arrangement of the evaluation value accumulation server 105 to which the present invention is applied. In FIG. 3, the evaluation value accumulation server 105 comprises an evaluation value storage unit 301, transceiver 302, controller 303, and evaluation value processing unit 304.

The evaluation value storage unit 301 stores a broadcast program, its corresponding evaluation value, and information (e.g., programming count, replay count, and rating) serving as a reference to decide an evaluation value.

The transceiver 302 receives an evaluation value obtainment request from each record/replay apparatus connected via the network 103, and sends back the evaluation value of each broadcast program. Also, the transceiver 302 receives, from each record/replay apparatus, information serving as a reference to decide an evaluation value.

The controller 303 includes a CPU, MPU, and the like, and performs various control operations for the evaluation value accumulation server 105. In response to an evaluation value obtainment request from the record/replay apparatus, the evaluation value processing unit 304 decides a final evaluation value based on evaluation values stored in the evaluation value storage unit 301, or information such as the programming count and replay count totaled from record/replay apparatuses. Then, the evaluation value processing unit 304 sends back the evaluation value of each requested broadcast program.

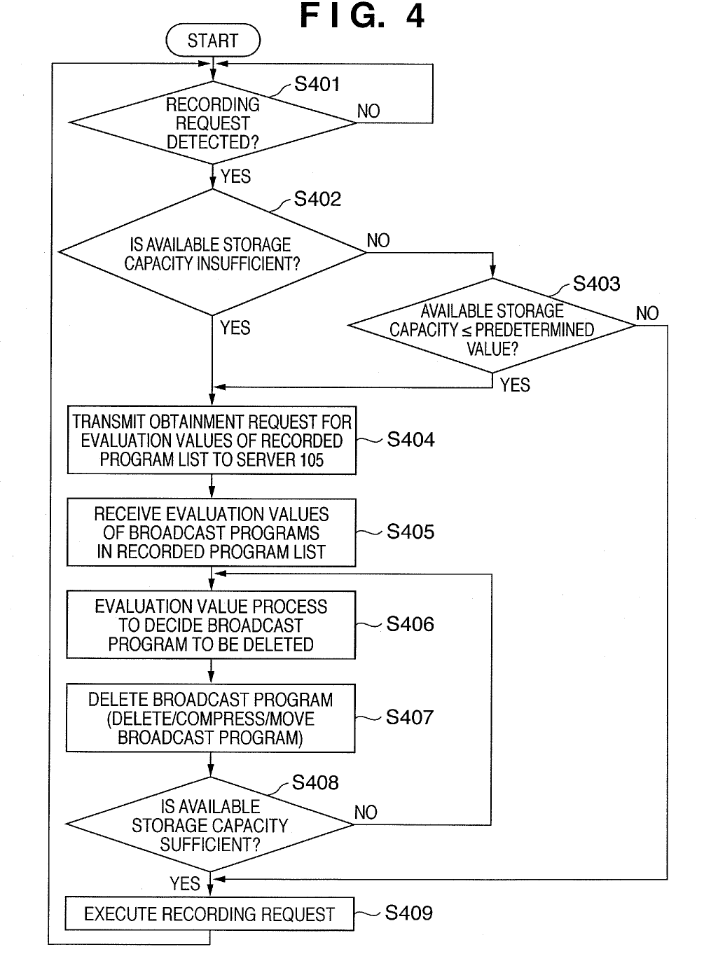

FIG. 4 is a flowchart showing the procedures of an automatic broadcast program deletion process by the record/replay apparatus in the first embodiment.

In step S401, the record/replay apparatus waits for a recording request for manual recording, recording programming, or the like from the user. If the record/replay apparatus detects a recording request, the process advances to step S402.

In step S402, if the record/replay apparatus detects a recording request in step S401, it obtains the current available storage capacity of the broadcast program storage unit 202, and determines whether the available storage capacity is sufficient to record a scheduled broadcast program.

If the record/replay apparatus determines that the available storage capacity is insufficient, the process advances to step S403. In step S403, the record/replay apparatus determines whether the available storage capacity is equal to or smaller than a predetermined value (e.g., 10% of the storage capacity of the broadcast program storage unit 202). If the record/replay apparatus determines that the available storage capacity is larger than the predetermined value, the available storage capacity is sufficient, and the process advances to step S409.

If the record/replay apparatus determines in step S402 that the available storage capacity is insufficient or if it determines in step S403 that the available storage capacity is equal to or smaller than the predetermined value, the record/replay apparatus transmits an obtainment request for the evaluation values of broadcast programs to the evaluation value accumulation server 105 in order to decide a broadcast program to be deleted from recorded programs in step S404.

In step S405, the record/replay apparatus receives the evaluation values of broadcast programs from the evaluation value accumulation server 105. In step S406, the record/replay apparatus compares the evaluation values of the broadcast programs received in step S405, and designates a broadcast program of the lowest evaluation value as a deletion target.

In step S407, the record/replay apparatus deletes the target broadcast program designated in step S406. Instead of deletion, the target broadcast program may be compressed to reduce its data amount and ensure an available storage capacity of the broadcast program storage unit 202. Alternatively, the target broadcast program may be moved to another storage medium such as a DVD or network-connected hard disk to ensure an available storage capacity of the broadcast program storage unit.

In step S408, the record/replay apparatus determines whether a sufficient available storage capacity has been ensured. The record/replay apparatus repeats the processes in steps S406 and S407 until a sufficient available storage capacity is ensured.

After a sufficient available storage capacity is ensured, the record/replay apparatus executes the recording request in step S409. Then, the process returns to step S401.

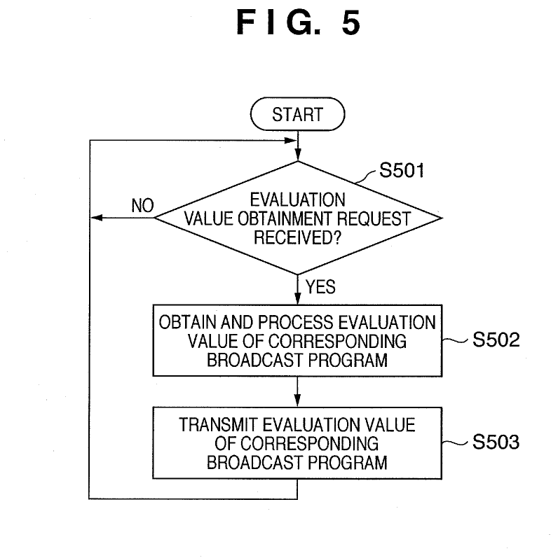

FIG. 5 is a flowchart showing the procedures of an evaluation value transmission/reception process by the evaluation value accumulation server in the first embodiment.

In step S501, the server waits for an evaluation value obtainment request from the record/replay apparatus. If the server receives the evaluation value obtainment request, the process advances to step S502 to obtain the evaluation value of a broadcast program from the evaluation value storage unit 301.

In step S503, the server sends back the obtained evaluation value of the broadcast program to the requesting record/replay apparatus. In the first embodiment, the display apparatus 209 shown in FIG. 2 and the record/replay apparatus 101 are separate apparatuses, but may be integrated.

As described above, the first embodiment can provide only high-quality broadcast programs to the user while freeing the user from a cumbersome broadcast program confirmation operation, broadcast program selection operation, and broadcast program deletion operation.

### Second Embodiment

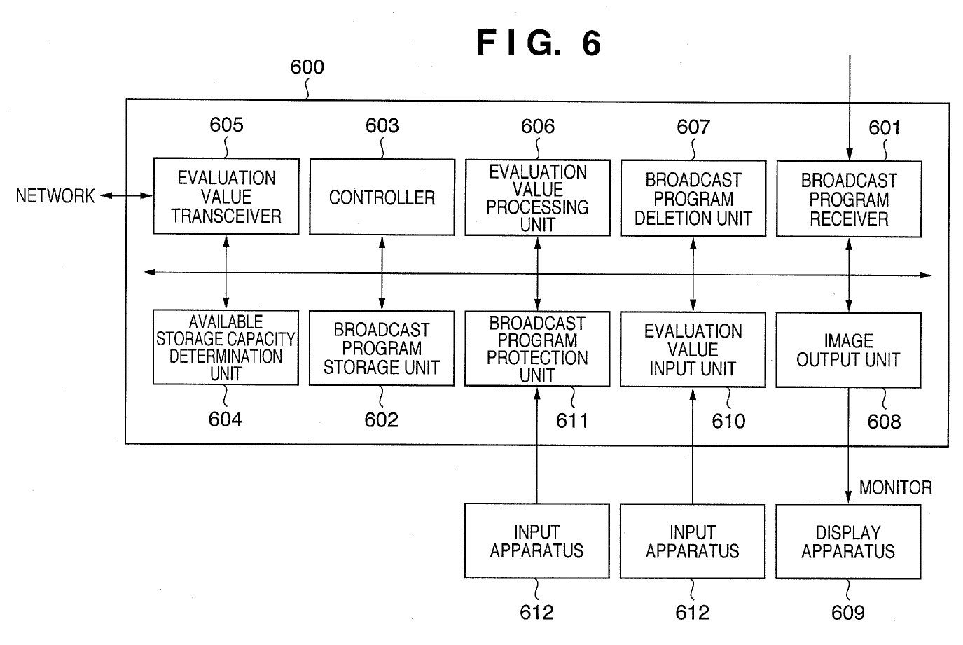

The second embodiment to be described below adopts the same arrangement as that shown in FIG. 1, and a description thereof will not be repeated. FIG. 6 is a functional block diagram showing an example of the arrangement of a record/replay apparatus according to the second embodiment to which the present invention is applied.

In FIG. 6, a record/replay apparatus 600 comprises a broadcast program receiver 601, broadcast program storage unit 602, controller 603, available storage capacity determination unit 604, evaluation value transceiver 605, evaluation value processing unit 606, broadcast program deletion unit 607, image output unit 608, evaluation value input unit 610, and broadcast program protection unit 611. The evaluation value input unit 610 is used to input an evaluation value.

The broadcast program receiver 601 includes a tuner, and receives broadcast waves and broadcast program contents such as video data and audio data from a network. The broadcast program storage unit 602 stores a received broadcast program in a storage medium such as a hard disk.

The controller 603 includes a CPU, MPU, and the like, and performs various control operations for the record/replay apparatus 600. When the user issues a recording request for manual recoding or recording programming, the available storage capacity determination unit 604 obtains the current available storage capacity of the broadcast program storage unit 602, and determines whether the available storage capacity is sufficient to store a broadcast program to be recorded. It is also possible to set the minimum value of the available storage capacity in advance and determine whether the available storage capacity becomes equal to or smaller than the set value, even if the user does not issue a recording request.

The evaluation value transceiver 605 is connected to an evaluation value accumulation server 105 via a network 103 to transmit/receive an evaluation value and information used to decide an evaluation value.

When the broadcast program storage unit 602 does not have a sufficient available storage capacity, the evaluation value transceiver 605 transmits an obtainment request for the evaluation values of broadcast programs to the evaluation value accumulation server 105 in order to decide a broadcast program to be deleted from recorded programs.

In the case of setting the minimum value of the available storage capacity in advance, when the available storage capacity becomes equal to or smaller than the set value, the evaluation value transceiver 605 transmits an evaluation value obtainment request to the evaluation value accumulation server 105. After transmitting the evaluation value obtainment request to the evaluation value accumulation server 105, the evaluation value transceiver 605 receives the evaluation values of broadcast programs.

The evaluation value transceiver 605 transmits, to the evaluation value accumulation server 105, information serving as a reference to decide the evaluation value of a broadcast program as needed. Examples of this information are reserved broadcast program information when the user reserves a broadcast program, and information on the replay count, replay time, and recording date & time of a broadcast program recorded by the user.

The evaluation value processing unit 606 decides to delete a broadcast program of the lowest evaluation value among broadcast programs stored in the broadcast program storage unit 602. The delete broadcast program decision process is repeated until a sufficient available storage capacity is ensured.

The broadcast program deletion unit 607 deletes a broadcast program designated by the evaluation value processing unit 606. The image output unit 608 is connected to an external display apparatus 609, and outputs video data of a broadcast program to the display apparatus 609.

The evaluation value input unit 610 accepts a broadcast program evaluation input from the user. The user inputs an evaluation from each input apparatus 612 (e.g., a remote controller, keyboard, or touch pad) connected to the record/replay apparatus 600 via a wire or wirelessly via infrared rays or the like.

For example, the user can input an evaluation out of five grades: “excellent”, “good”, “satisfactory”, “fair”, and “poor”. Each user can input his subjective evaluation.

Evaluations by users can be transmitted from record/replay apparatuses to the server, totaled, and averaged to obtain a general evaluation of the broadcast program.

For example, if the totaled evaluation value of a given broadcast program is higher than those of other broadcast programs, this broadcast program can be estimated to be a good broadcast program highly evaluated by many users.

It is also possible to allow the user to input an evaluation value for only a broadcast program he viewed for a predetermined time or more or at a predetermined percentage or more.

The broadcast program protection unit 611 makes a protection setting to prevent deletion of a broadcast program stored in the broadcast program storage unit 602. Protection is set by displaying, on the display apparatus 609, a list (recorded program list) of broadcast programs recorded in the broadcast program storage unit 602, and prompting the user to select a broadcast program not to be deleted with a remote controller or the like.

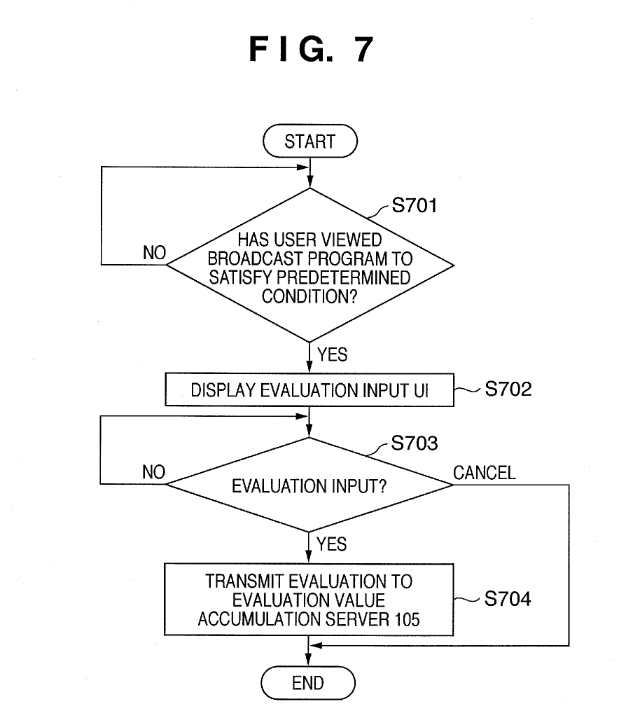

FIG. 7 is a flowchart showing the procedures of an evaluation input process in the second embodiment.

In step S701, the record/replay apparatus determines whether the user has viewed a target broadcast program to satisfy a predetermined condition. The predetermined condition is, for example, a predetermined time (e.g., 30 min) or more or a predetermined percentage (e.g., 50%) or more. Under this condition, the user is considered to have viewed the broadcast program long enough to evaluate it. If the user does not satisfy this condition, he cannot input any evaluation.

If the user satisfies the condition in step S701, the display apparatus 609 displays an evaluation input UI in step S702 to wait for an evaluation input from the user. The user inputs an evaluation from the input apparatus 612 (e.g., a remote controller, keyboard, or touch pad) connected via a wire or wirelessly via infrared rays or the like.

If the user inputs an evaluation in step S703, the process advances to step S704. If the user cancels the process without inputting any evaluation, the evaluation input process ends. In step S704, the record/replay apparatus transmits the input evaluation to the evaluation value accumulation server 105.

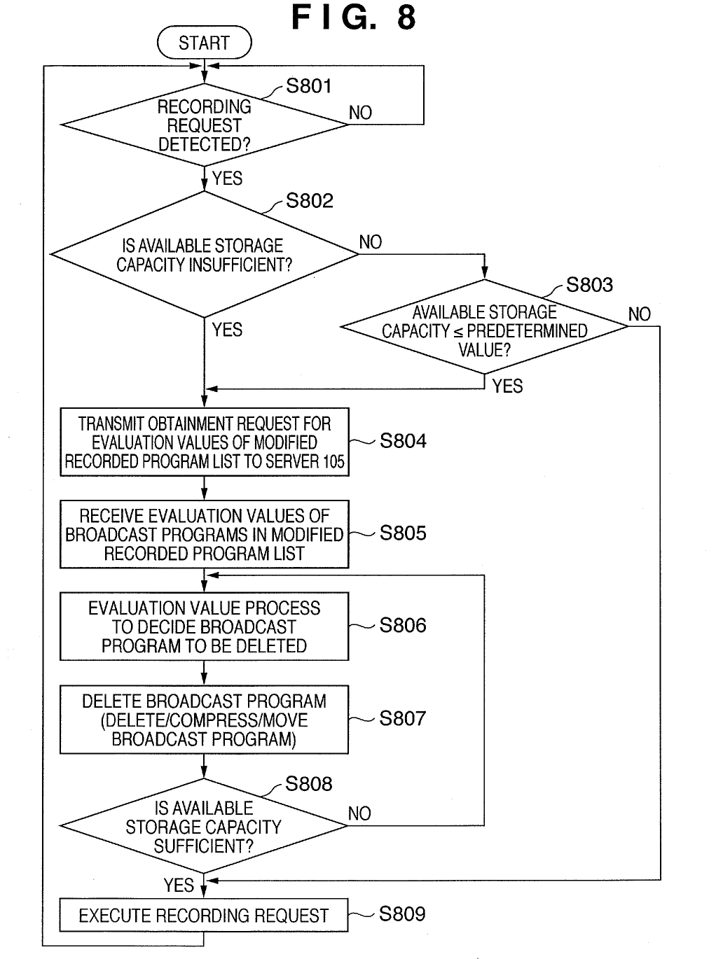

FIG. 8 is a flowchart showing the procedures of an automatic broadcast program deletion process by the record/replay apparatus in the second embodiment.

In step S801, the record/replay apparatus waits for a recording request for manual recording, recording programming, or the like from the user. If the record/replay apparatus detects a recording request, the process advances to step S802.

In step S802, if the record/replay apparatus detects a recording request in step S801, it obtains the current available storage capacity of the broadcast program storage unit 602, and determines whether the available storage capacity is sufficient to record a scheduled broadcast program. If the record/replay apparatus determines that the available storage capacity is insufficient, the process advances to step S803.

In step S803, the record/replay apparatus determines whether the available storage capacity is equal to or smaller than a predetermined value (e.g., 10% of the storage capacity of the broadcast program storage unit 602). If the record/replay apparatus determines that the available storage capacity is larger than the predetermined value, the available storage capacity is sufficient, and the process advances to step S809.

In step S804, if the record/replay apparatus determines in step S802 that the available storage capacity is insufficient or if it determines in step S803 that the available storage capacity is equal to or smaller than the predetermined value, the record/replay apparatus transmits an obtainment request for the evaluation values of broadcast programs to the evaluation value accumulation server in order to decide a broadcast program to be deleted from recorded programs.

A list of broadcast programs whose evaluations are requested is a modified recorded program list prepared by excluding deletion-inhibited broadcast programs protected by the broadcast program protection unit 611 from the recorded program list. That is, in step S804, the record/replay apparatus requests the evaluations of broadcast programs in the modified recorded program list of the evaluation value accumulation server 105.

This can reduce the network load and the process by the server to send back a response at high speed. In the above-described example, the evaluations of broadcast programs in the modified recorded program list are requested of the evaluation value accumulation server 105. Instead, the evaluation values of all recorded programs may be requested. In this case, deletion-inhibited broadcast programs are excluded when comparing the evaluation values of the broadcast programs to decide a broadcast program to be deleted.

In step S805, the record/replay apparatus receives the evaluation values of broadcast programs in the modified recorded program list from the evaluation value accumulation server. In step S806, the record/replay apparatus compares the evaluation values of the broadcast programs received in step S805, and designates a broadcast program of the lowest evaluation value as a deletion target.

In step S807, the record/replay apparatus deletes the target broadcast program designated in step S806. Instead of deletion, the target broadcast program may be compressed to reduce its data amount and ensure an available storage capacity of the broadcast program storage unit 602. Alternatively, the target broadcast program may be moved to another storage medium such as a DVD or network-connected hard disk to ensure an available storage capacity of the broadcast program storage unit.

In step S808, the record/replay apparatus determines whether a sufficient available storage capacity has been ensured. The record/replay apparatus repeats the processes in steps S806 and S807 until a sufficient available storage capacity is ensured. After a sufficient available storage capacity is ensured, the record/replay apparatus executes the recording request in step S809. Then, the process returns to step S801.

As described above, the second embodiment can provide only high-quality broadcast programs to the user while freeing the user from a cumbersome broadcast program confirmation operation, broadcast program selection operation, and broadcast program deletion operation.

In addition, the evaluation of a broadcast program becomes more reliable by transmitting evaluations by users from record/replay apparatuses to the server and totaling them. Broadcast programs of low evaluations are automatically deleted, eliminating work cumbersome to the user such as selection of broadcast programs, confirmation of contents, and deletion. The user can, therefore, be provided with only highly evaluated broadcast programs.

Since the protection setting to prevent automatic deletion can be made for broadcast programs, broadcast programs can be automatically deleted while leaving those the user wants to view.

### Other Embodiments

The objects of the present invention are also achieved by supplying a software program for implementing the functions of the above-described embodiments to a computer or CPU, and reading out and executing the supplied program by the computer or CPU.

In this case, the program is supplied directly from a storage medium which stores the program, or downloaded from another computer, database, or the like (not shown) connected to the Internet, a commercial network, a local area network, or the like.

So long as the computer can implement the functions of the above-described embodiments, the program may take the form of an object code, a program executed by an interpreter, script data supplied to the OS, or the like.

The objects of the present invention are also achieved by supplying a storage medium which stores a software program for implementing the functions of the above-described embodiments to a computer, and reading out and executing the program stored in the storage medium by the computer or CPU.

In the above-described embodiments, the ROM stores the program, but the present invention is not limited to this. Examples of the storage medium which supplies the program are a RAM, NV-RAM, floppy® disk, hard disk, optical disk, magneto-optical disk, CD-ROM, MO, CD-R, CD-RW, DVD (DVD-ROM, DVD-R, DVD-RW, and DVD-RAM), magnetic tape, nonvolatile memory card, and another type of ROM as long as the storage medium can store the program.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-152149, filed May 31, 2006, which is hereby incorporated by reference herein in its entirety.

What is claimed is:

1. A record/replay apparatus comprising:
a receiver which receives a broadcast program;
a storage unit adapted to store the broadcast program received by said receiver;
an obtaining unit adapted to obtain evaluation values of broadcast programs via a network from an accumulation server that stores evaluation values of broadcast programs;
a processing unit adapted to decides a broadcast program to be deleted based on the evaluation values obtained by said obtaining unit; and
a deletion unit adapted to automatically delete the broadcast program, deletion of which is decided by said processing unit, from said storage unit.

2. The apparatus according to claim 1, further comprising a determination unit adapted to determine an available storage capacity of said storage unit,
wherein when said determination unit determines that the available storage capacity is not more than a predetermined storage capacity, deletion is performed.

3. The apparatus according to claim 1, wherein said processing unit determines whether an evaluation value of a broadcast program is not more than a predetermined value, and when the evaluation value of the broadcast program is not more than the predetermined value, decides to delete the broadcast program.

4. The apparatus according to claim 1, wherein said processing unit decides to delete a broadcast program of the lowest evaluation value.

5. The apparatus according to claim 1, further comprising a transmitter adapted to transmit an evaluation value to the accumulation server.

6. The apparatus according to claim 4, further comprising an input unit adapted to input an evaluation value to be transmitted to the accumulation server.

7. The apparatus according to claim 1, further comprising a protection unit adapted to make a setting to prevent deletion of a broadcast program stored in said storage unit, wherein a broadcast program set as the one to be prevented from deletion by said protection unit is excluded from automatic deletion targets.

8. A record/replay method comprising:
receiving a broadcast program;
storing the received broadcast program in a storage unit;
obtaining evaluation values of broadcast programs via a network from an accumulation server that stores evaluation values of broadcast programs;
deciding a broadcast program to be deleted based on the obtained evaluation values; and
automatically deleting the broadcast program, deletion of which is decided, from the storage unit.

9. The method according to claim 8, further comprising determining an available storage capacity of the storage unit,
wherein when the available storage capacity is determined to be not more than a predetermined storage capacity, deletion is performed.

10. The method according to claim 8, wherein in the deciding step, whether an evaluation value of a broadcast program is not more than a predetermined value is determined, and when the evaluation value of the broadcast program is not more than the predetermined value, the broadcast program is decided to be deleted.

11. The method according to claim 8, wherein in the deciding step, a broadcast program of the lowest evaluation value is decided to be deleted.

12. The method according to claim 8, further comprising transmitting an evaluation value to the accumulation server.

13. The method according to claim 12, further comprising inputting an evaluation value to be transmitted to the accumulation server.

14. The method according to claim 8, further comprising making a setting to prevent deletion of a broadcast program stored in the storage unit,
wherein a broadcast program set as the one to be prevented from deletion is excluded from automatic deletion targets.

15. A program stored in a computer-readable storage medium, the program causing a computer to execute
receiving a broadcast program,
storing the received broadcast program received in a storage unit,
obtaining evaluation values of broadcast programs via a network from an accumulation server that stores evaluation values of broadcast programs,
deciding a broadcast program to be deleted based on the obtained evaluation values, and
automatically deleting the broadcast program, deletion of which is decided, from the storage unit.

16. The program according to claim 15, further comprising determining an available storage capacity of the storage unit,
wherein when the available storage capacity is determined to be not more than a predetermined storage capacity, deletion is performed.

17. The program according to claim 15, wherein in the deciding step, whether an evaluation value of a broadcast program is not more than a predetermined value is determined, and when the evaluation value of the broadcast program is not more than the predetermined value, the broadcast program is decided to be deleted.

18. The program according to claim 15, wherein in the deciding step, a broadcast program of the lowest evaluation value is decided to be deleted.

19. The program according to claim 15, further comprising transmitting an evaluation value to the accumulation server.

20. The program according to claim 19, further comprising inputting an evaluation value to be transmitted to the accumulation server.

21. The program according to claim 15, further comprising making a setting to prevent deletion of a broadcast program stored in the storage unit,
wherein a broadcast program set as the one to be prevented from deletion is excluded from automatic deletion targets.
